(19) United States
(12) Patent Application Publication
(10) Pub. No.: US 2024/0338849 A1
(43) Pub. Date: Oct. 10, 2024

(54) COMPONENT POSTURE INFORMATION ACQUIRING DEVICE AND COMPONENT POSTURE DETERMINATION METHOD

(71) Applicant: KONICA MINOLTA, INC., Tokyo (JP)

(72) Inventors: Tomoyoshi YUKIMOTO, Tokyo (JP); Murali Karteek GANDIBOYINA, Tokyo (JP)

(73) Assignee: KONICA MINOLTA, INC., Tokyo (JP)

(21) Appl. No.: 18/608,946

(22) Filed: Mar. 19, 2024

(30) Foreign Application Priority Data
Apr. 4, 2023 (JP) 2023-060687

(51) Int. Cl. G06T 7/73; B25J 9/16; G06V 10/25; G06V 20/52

(52) U.S. Cl. CPC G06T 7/74; B25J 9/1697; G06V 10/25; G06V 20/52; G06T 2207/30232

(57) ABSTRACT

A component posture information acquiring device acquires information of a posture of a component from a hand that holds the component arranged on a picking table and places the component at a supply position. The component posture information acquiring device includes a distance measure that is provided in a vicinity of a component holding part of the hand and measures a distance from the distance measure to the component, and a hardware processor that determines the posture of the component, in which the hardware processor determines a position of a region of interest to be used for determining the posture of the component based on information of an arrangement position of the distance measure when the distance to the component measured by the distance measure becomes a predetermined distance, and determines the posture of the component based on a feature amount in the region of interest.

### CROSS-REFERENCE TO RELATED APPLICATION

The entire disclosure of Japanese patent Application No. 2023-060687, filed on Apr. 4, 2023, is incorporated herein by reference in its entirety.

### BACKGROUND OF THE INVENTION

### 1. Technical Field

The present invention relates to a component posture information acquiring device and a component posture determination method.

### 2. Description of Related Art

Conventionally, image recognition processing is known in which an image of a workpiece (component) is captured by a camera and the position and inclination of the workpiece are obtained. Japanese Unexamined Patent Publication No. 1997-245177 describes a method for selecting image recognition conditions for selecting optimal image recognition conditions for each component.

In the method for selecting image recognition conditions described in Japanese Unexamined Patent Publication No. 1997-245177, imaging conditions for a plurality of types of workpieces and a plurality of types of processing conditions are set as recognition conditions. The imaging conditions are, for example, the angle of the workpiece and the illumination intensity, and the processing conditions are, for example, a preprocessing method and a recognition processing method for a captured image. Next, the image recognition processing is executed under all the image recognition conditions obtained by combining the imaging conditions and the processing conditions, and a recognition error is calculated for each image recognition condition. Then, an image recognition condition with the smallest recognition error is selected as the optimum image recognition condition.

### SUMMARY OF THE INVENTION

Incidentally, although an outer shape of a component is likely to be clearly captured, a surface shape of the component is unlikely to be clearly captured, unlike the outer shape in some cases. Therefore, when an image of the component is captured under the same image recognition conditions, the amount of information of the surface shape obtained from the captured image is small. Therefore, it is assumed that a recognition error when image recognition processing is performed by the method for selecting image recognition conditions described in Japanese Unexamined Patent Publication No. 1997-245177 increases, and the accuracy of determining a posture (front or back) of a component decreases.

For example, a method for determining a posture of a component by focusing on a feature amount of a surface shape of the component and determining whether the detected feature amount is a feature amount on a first surface or a feature amount on a second surface is considered. According to this method, even if precise information of the surface shape cannot be acquired, the posture of the component can be determined.

However, for example, when a component is in contact with each other or overlaps another component, and boundary information of the component cannot be accurately acquired, an acquired feature amount cannot be accurately associated with the component. Alternatively, in a case where the feature amount is acquired based on information of the outer shape of the component, the feature amount itself cannot be acquired. Therefore, the determination of the posture of the component also cannot be performed.

The present invention has been made in view of such a situation, and an object of the present invention is to make it possible to determine a posture of a component even when the component is in contact with each other or overlaps another component.

In order to achieve at least one object described above, a component posture information acquiring device according to one aspect of the present invention acquires information of a posture of a component from a hand that holds the component arranged on a picking table and places the component at a supply position. The component posture information acquiring device includes a distance measure and a hardware processor. The distance measure is provided in a vicinity of a component holding part of the hand that holds the component arranged on the picking table and places the component at the supply position, and measures a distance from the distance measure to the component. The hardware processor determines a region of interest to be used for determining the posture of the component based on information of an arrangement position of the distance measure when the measured distance becomes a predetermined distance, and determines the posture of the component based on a feature amount in the region of interest.

### BRIEF DESCRIPTION OF THE DRAWINGS

The advantages and features provided by one or more embodiments of the invention will become more fully understand from the detailed description given hereinbelow and the appended drawings which are given by way of illustration only, and thus are not intended as a definition of the limits of the present invention.

FIG. 1 is a perspective view of a component supply device according to an embodiment of the present invention;

FIG. 2 is a top view of the component supply device according to the embodiment of the present invention;

FIG. 3 is a side view of the component supply device according to the embodiment of the present invention;

FIG. 4 is a side view of a provider included in the component supply device according to the embodiment of the present invention;

FIG. 5 is a diagram illustrating a configuration of a hand block of the provider included in the component supply device according to the embodiment of the present invention;

FIG. 6 is a block diagram illustrating an example of a configuration of a control system included in the component supply device according to the embodiment of the present invention;

FIGS. 7A and 7B are diagrams illustrating a state in which distances to a component measured by distance measuring sensors according to the embodiment of the present invention are a target distance;

FIGS. 8A and 8B are diagrams illustrating a correspondence relationship between the target distance, a reference position, and the position of a region of interest according to the embodiment of the present invention;

FIG. 9 is a block diagram illustrating an example of a hardware configuration of the component supply device according to the embodiment of the present invention;

FIG. 10 is a diagram illustrating a component supply operation of the component supply device according to the embodiment of the present invention;

FIG. 11 is a flowchart illustrating an example of a procedure of a posture determination process according to the embodiment of the present invention;

FIGS. 12A and 12B are diagrams illustrating each process of the posture determination process according to the embodiment of the present invention;

FIGS. 13A, 13B, and 13C are diagrams illustrating each process of the posture determination process according to the embodiment of the present invention;

FIG. 14 is a diagram illustrating an example of determining the arrangement positions of the distance measuring sensors in a state in which a plurality of components are stacked according to the embodiment of the present invention;

FIG. 15 is a diagram illustrating an example of a positional relationship between the distance measuring sensors and a component according to the embodiment of the present invention;

FIG. 16 is a graph illustrating an example of values measured by the distance measuring sensors according to the embodiment of the present invention;

FIGS. 17A and 17B are diagrams illustrating an example of the adjustment of the inclination of a hand according to the embodiment of the present invention; and

FIG. 18 is a diagram illustrating an example in which a region of interest is set in a wide range on a component according to a modification example of the present invention.

### DETAILED DESCRIPTION

Hereinafter, one or more embodiments of the present invention will be described with reference to the drawings. However, the scope of the invention is not limited to the disclosed embodiments.

In this specification and the drawings, constituent elements having substantially the same functions or configurations are denoted by the same reference numerals, and redundant description of the constituent elements will be omitted.

### <Configuration of Component Supply Device>

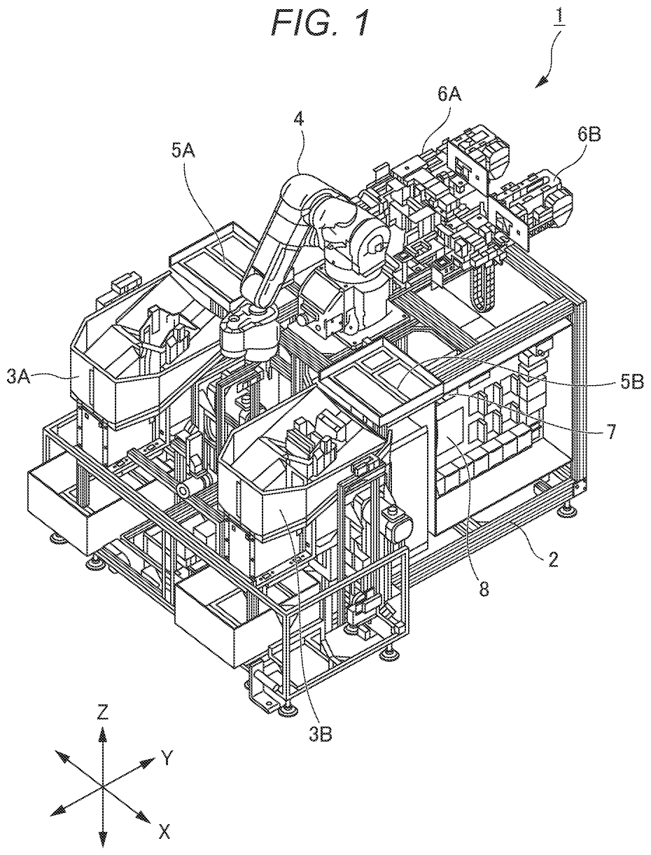

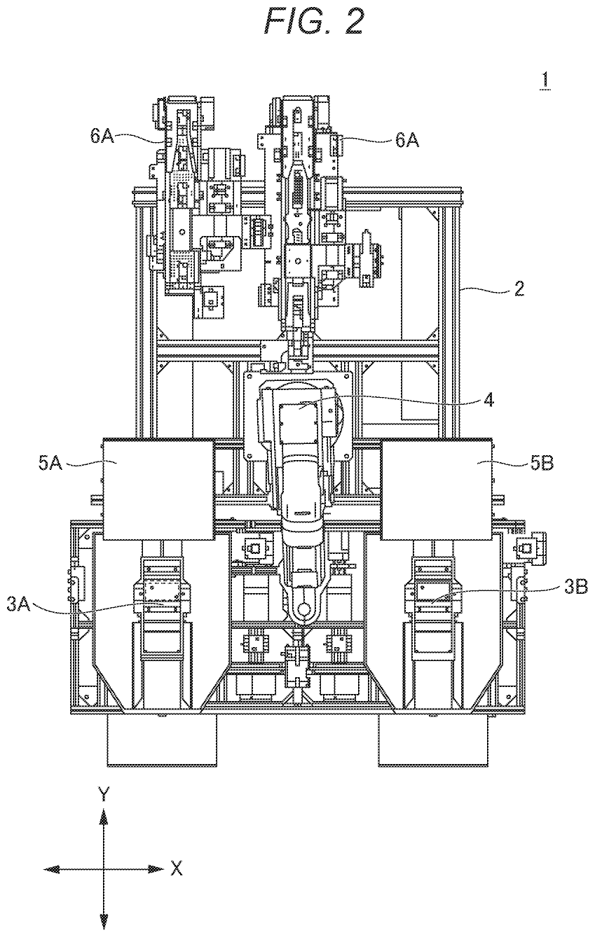

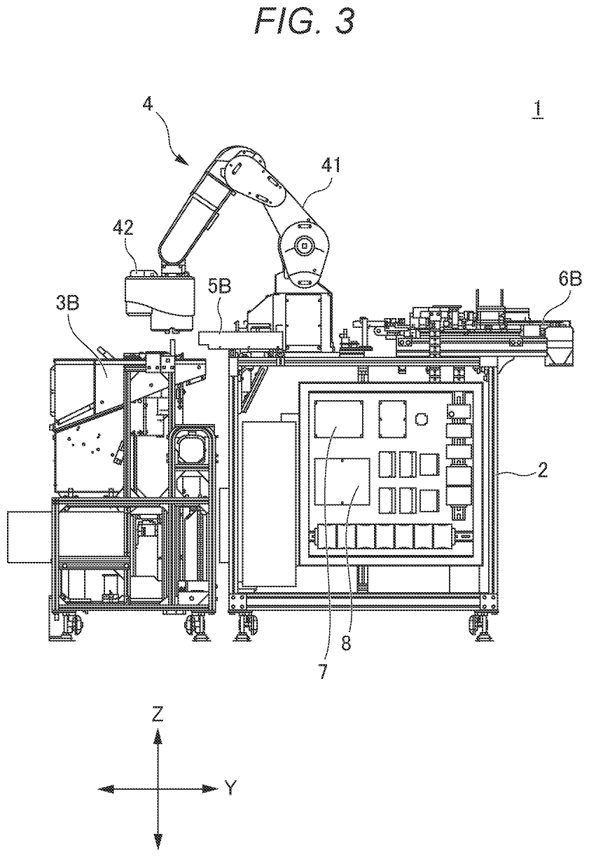

First, a configuration of a component supply device according to an embodiment of the present invention will be described with reference to FIGS. 1 to 3. FIG. 1 is a perspective view of the component supply device 1, FIG. 2 is a top view of the component supply device 1, and FIG. 3 is a side view of the component supply device 1.

As illustrated in FIG. 1, the component supply device 1 (an example of a component posture information acquiring device) according to the present embodiment includes a frame 2, containers 3A and 3B, a provider 4, picking tables 5A and 5B, placing tables 6A and 6B, a control board 7, and an operation display 8. The containers 3A and 3B, the provider 4, the picking tables 5A and 5B, the placing tables 6A and 6B, and the control board 7 are attached to the frame 2. The component supply device 1 places components stored in the containers 3A and 3B in aligned postures on the placing tables 6A and 6B, and supplies the components to a device for the next process.

The frame 2 is formed in a substantially rectangular parallelepiped shape and has a width, a depth, and a height. In FIGS. 1 to 3, an X-axis direction indicates a width direction of the frame 2, a Y-axis direction indicates a depth direction of the frame 2, and a Z-axis direction indicates a height direction of the frame 2. The X-axis direction and the Y-axis direction correspond to two horizontal axis directions that are two axis directions parallel to a horizontal plane, and the Z-axis direction corresponds to a vertical direction that is a direction orthogonal to the horizontal plane. The frame 2 includes lateral members extending in the X-axis direction or the Y-axis direction and longitudinal members extending in the Z-axis direction.

The containers 3A and 3B are arranged on one side of the frame 2 in the Y-axis direction. The containers 3A and 3B face each other at an appropriate distance in the X-axis direction. Each of the containers 3A and 3B is formed in a substantially box shape with an opening at its upper part. Each of the containers 3A and 3B is provided with an elevating mechanism (not illustrated) that moves the bottom part of the container in the Z-axis direction. Thus, each of the containers 3A and 3B can change the capacity of the container and a height position of a component stored in the container.

For example, a first component is stored in the container 3A, and a second component different from the first component is stored in the container 3B. In this case, the component supply device 1 supplies the first component and the second component to the device for the next process. Furthermore, first components may be stored in the containers 3A and 3B in a first period, and second components may be stored in the containers 3A and 3B in a second period different from the first period. In this case, the component supply device 1 supplies the first components to the device for the next process in the first period and supplies the second components to the device for the next process in the second period.

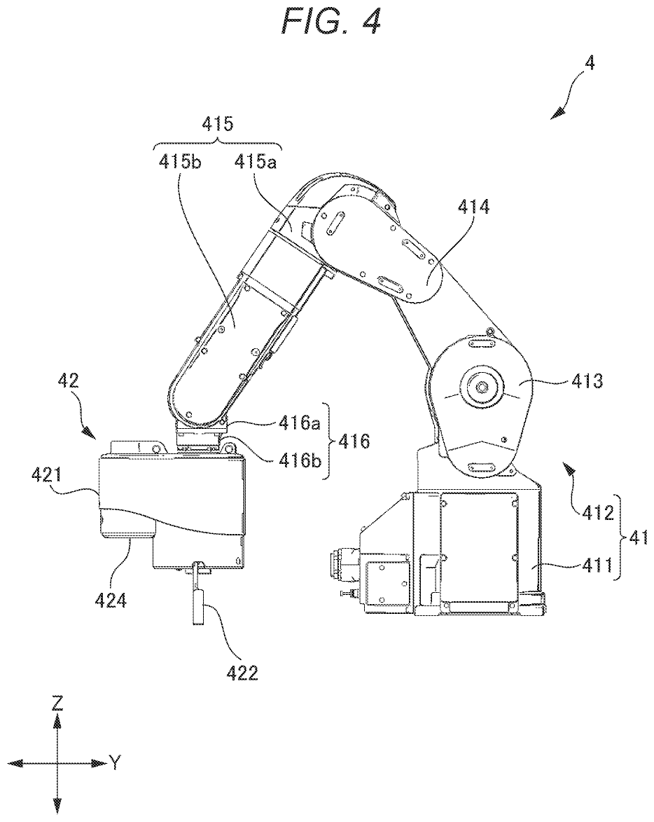

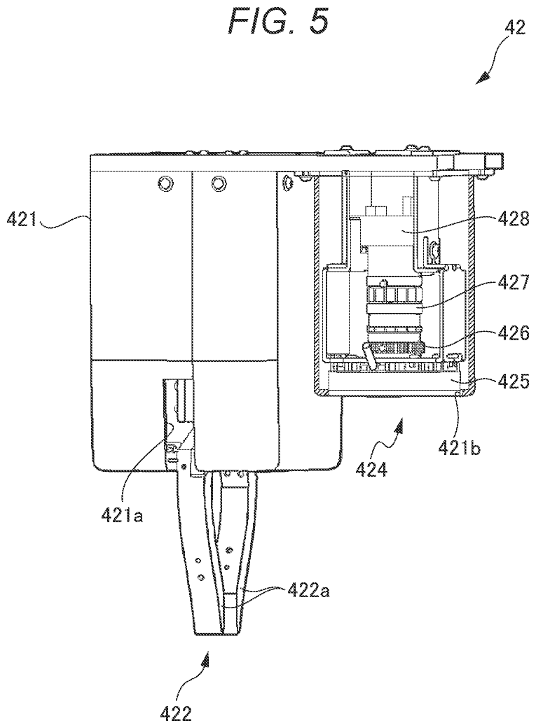

The provider 4 is arranged at a substantially central portion of an upper portion of the frame 2. The provider 4 holds one or a plurality of components from among a large number of first components or a large number of second components stored in the container 3A or 3B and supplies the one or plurality of components by dropping the one or plurality of components onto the picking table 5A or 5B. Thus, the one or more first components or the one or more second components are placed on the picking table 5A or 5B. In addition, the provider 4 holds the first components or the second components placed on the picking table 5A or 5B one by one, and supplies the first components or the second components to the placing table 6A or 6B. The configuration of the provider 4 will be described later with reference to FIGS. 4 and 5.

The picking tables 5A and 5B are arranged on both sides of the provider 4 in the X-axis direction. Furthermore, the picking tables 5A and 5B are adjacent to the containers 3A and 3B, respectively, in the Y-axis direction. The picking tables 5A and 5B are located higher than the containers 3A and 3B.

In the Z-axis direction, a part of the picking table 5A overlaps the container 3A. Thus, a component dropped from a part of the picking table 5A is stored in the container 3A again. In the Z-axis direction, a part of the picking table 5B overlaps the container 3B. Thus, a component dropped from a part of the picking table 5B is stored in the container 3B again.

Each of the placing tables 6A and 6B includes a belt conveyor that conveys a component in the Y-axis direction. The placing tables 6A and 6B are attached to an X-axis moving mechanism (not illustrated). The X-axis moving mechanism moves the placing tables 6A and 6B in the X-axis direction. The placing tables 6A and 6B convey the components supplied from the provider 4 in the Y-axis direction and position the components at predetermined positions. The positioned components are supplied to the device for the next process.

As illustrated in FIGS. 1 and 3, the control board 7 is attached to a side portion of the frame 2.

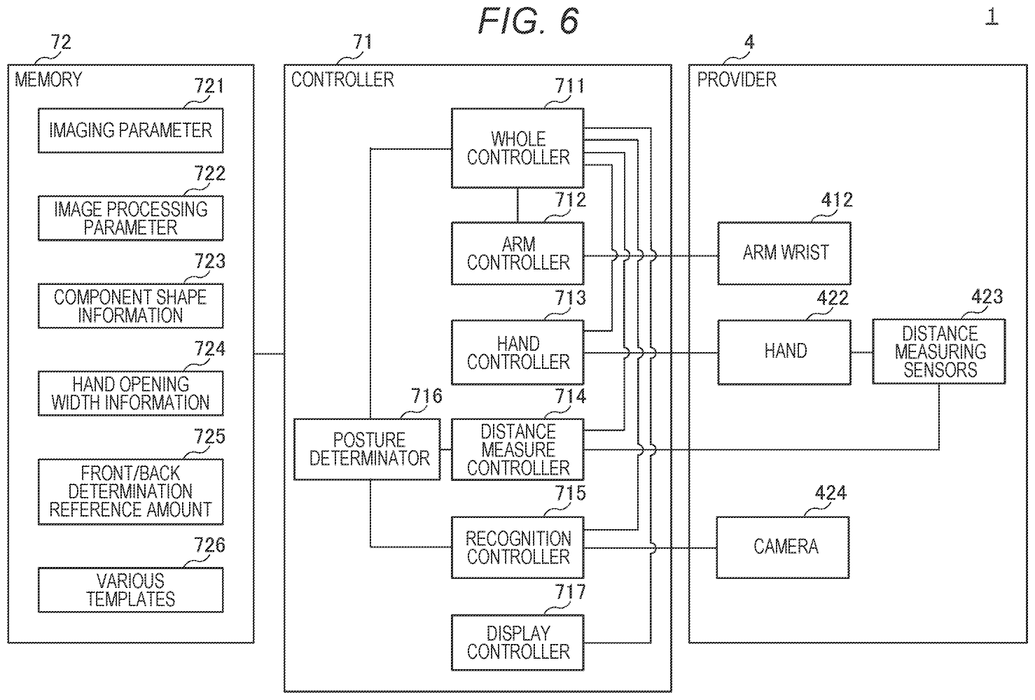

The control board 7 is provided with a controller 71 (see FIG. 6) that controls the operations of the containers 3A and 3B, the provider 4, and the placing tables 6A and 6B.

The operation display 8 displays details of various settings related to the supply of the components. The details of the various settings may include, for example, the types of the components to be supplied, the number of remaining components, a determination region to be described later, a first reference amount, a second reference amount, and the like. The first reference amount is a feature amount serving as a reference of a surface shape of a first surface (for example, a surface on the front side), and the second reference amount is a feature amount serving as a reference of a surface shape of a second surface (for example, a surface on the back side). The first reference amount and the second reference amount will be described later.

Further, the operation display 8 displays an error. The error may include, for example, a malfunction in the provider 4.

The operation display 8 is constituted by, for example, a touch screen display. That is, the operation display 8 also serves as an input part for inputting various settings related to an operation of supplying a component. Then, the operation display 8 displays an operation screen. While viewing the operation screen displayed on the operation display 8, a user performs input of various settings related to the operation of supplying a component, an instruction to perform the operation of supplying the component, and the like. The settings input using the operation display 8 are supplied to the controller 71 (see FIG. 6) of the control board 7.

### [Configuration of Provider]

Next, the configuration of the provider 4 will be described with reference to FIGS. 4 and 5.

FIG. 4 is a side view of the provider 4 included in the component supply device 1. FIG. 5 is a diagram illustrating a configuration of a hand block of the provider 4 included in the component supply device 1.

As illustrated in FIG. 4, the provider 4 includes an arm block 41 and the hand block 42 connected to the arm block 41. The arm block 41 includes a support base 411 and an arm 412 attached to the support base 411. The support base 411 is fixed to the frame 2 (see FIGS. 1 to 3). The support base 411 rotatably supports the arm 412.

The arm 412 freely moves the hand block 42 in the X-axis direction, the Y-axis direction, and the Z-axis direction. Further, the arm 412 freely rotates the hand block 42 around the X axis, the Y axis, and the Z axis. The arm 412 includes a base member 413, a first link member 414, a second link member 415, and a connecting member 416.

The base member 413 is rotatably connected to the support base 411. The base member 413 rotates about the Z axis (first axis). One end part of the first link member 414 is rotatably connected to the base member 413. The first link member 414 rotates about an axis (second axis) extending in the horizontal direction.

The second link member 415 has a rotary part 415a and a revolving part 415b connected to the rotary part 415a. The rotary part 415a is rotatably connected to the other end part of the first link member 414. The rotary part 415a rotates about an axis (third axis) extending in the horizontal direction. The revolving part 415b is rotatably connected to the rotary part 415a. The revolving part 415b rotates about an axis (fourth axis) extending in a direction in which the revolving part 415b is connected to the rotary part 415a.

The connecting member 416 includes a rotary part 416a and a revolving part 416b connected to the rotary part 416a. The rotary part 416a is rotatably connected to the revolving part 415b of the second link member 415. The rotary part 416a rotates about an axis (fifth axis) extending in the horizontal direction. The revolving part 416b is rotatably connected to the rotary part 416a. The revolving part 416b rotates about an axis (sixth axis) extending in a direction in which the revolving part 416b is connected to the rotary part 416a.

As illustrated in FIG. 5, the hand block 42 includes a housing 421, a hand 422, and a camera 424. The hand 422 and the camera 424 are attached to the housing 421.

The housing 421 is connected to the revolving part 416b (see FIG. 4) of the connecting member 416 included in the arm 412. The housing 421 is a substantially rectangular parallelepiped casing. A hand hole 421a and a camera hole 421b are formed in a lower surface of the housing 421. The hand 422 is passed through the hand hole 421a. The camera hole 421b exposes an illumination (described later) 425 of the camera 424.

The hand 422 includes two holding pieces 422a. An opening and closing mechanism (not illustrated) that opens and closes the two holding pieces 422a and an elevating mechanism (not illustrated) that elevates and lowers the plurality of holding pieces are provided in the housing 421. The two holding pieces 422a are elevated and lowered by the elevating mechanism, whereby lengths by which the holding pieces 422a protrude from the hand hole 421a are changed. When the lengths by which the two holding pieces 422a protrude from the hand hole 421a are increased, a space for holding a component becomes wider, and the number of components to be held increases. On the other hand, when the lengths by which the two holding pieces 422a protrude from the hand hole 421a are shortened, the space for holding a component becomes narrower, and the number of components to be held decreases.

The two holding pieces 422a can also hold one component at their distal end parts. The hand 422 holds one or a plurality of components from a large amount of components stored in the container 3A or a large amount of components stored in the container 3B and supplies the one or the plurality of components to the picking table 5A or the picking table 5B. On the other hand, the hand 422 holds one component from one or a plurality of components placed on the picking table 5A or 5B and supplies the component to the placing table 6A or 6B.

In addition, a distance measuring sensor 423 (an example of a distance measure, see FIG. 6) is provided in the vicinity of each of component holding parts of the two holding pieces 422a. The distance measuring sensors 423 measure distances to side surface parts of an object (component) positioned between the two holding pieces 422a in an open state. Information (hereinafter, also referred to as “distance measurement result information”) of the distances to the side surface parts of the component measured by the distance measuring sensors 423 is output to the controller 71 (see FIG. 6).

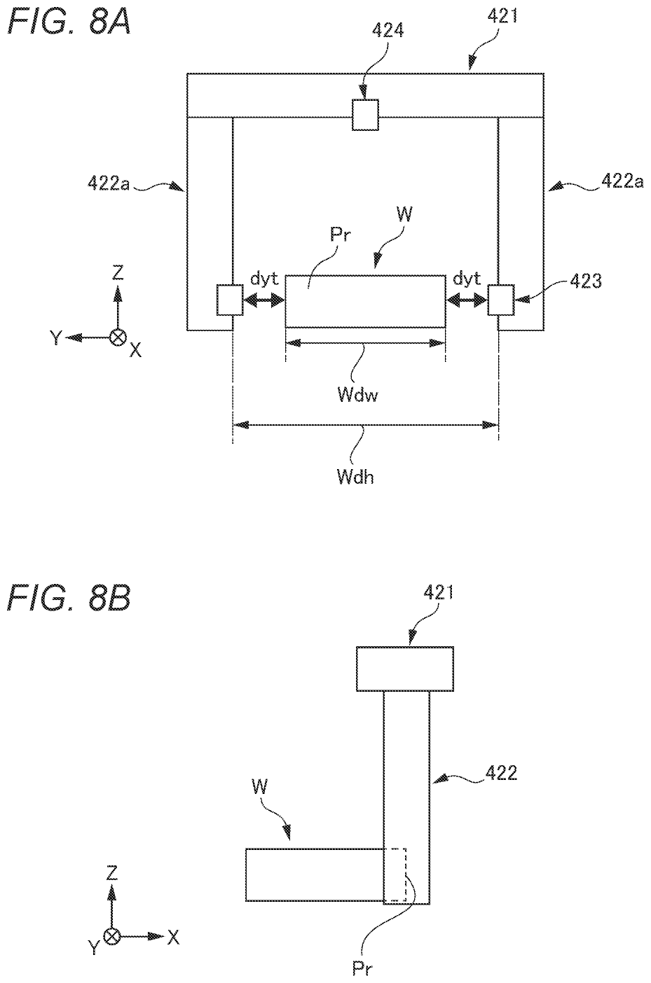

In the present embodiment, the distance measurement result information obtained by the distance measuring sensors 423 is used as information for determining the position of a region of interest including a feature amount necessary for the determination of the posture of the component. A method for determining the position of the region of interest based on the distance measurement result information will be described later with reference to FIGS. 8A and 8B.

The camera 424 is housed in the housing 421. The camera 424 includes the illumination 425, a polarizing filter 426, a plurality of lenses 427, and a camera body 428. These components constituting the camera 424 are arranged in the order of the illumination 425, the polarizing filter 426, the plurality of lenses 427, and the camera body 428 from the subject side of the camera 424. Examples of a subject may include components on the picking tables 5A and 5B, components stored in the containers 3A and 3B, and a component held by the hand 422.

The illumination 425 is exposed from the camera hole 421b. The illumination 425 is formed in a ring shape having an imaging hole for passing light from the subject. The illumination 425 irradiates the subject with light. The illumination 425 is configured to be able to adjust the amount of light in a stepwise manner. Turning on and off of the illumination 425 and the amount of light of the illumination 425 are controlled by a recognition controller 715 of the controller 71. The recognition controller 715 will be described later.

A polarizing film (not illustrated) is arranged in the imaging hole of the illumination 425. The polarizing filter 426 is opposed to the imaging hole of the illumination 425. The polarizing film and the polarizing filter 426 remove a specular reflection component of the light reflected from the subject. The light that was reflected from the subject and from which the specular reflection component was removed by the polarizing film and the polarizing filter 426 passes through the plurality of lenses 427.

The plurality of lenses 427 form a subject image on a light receiving surface of an imaging element in the camera body 428. The plurality of lenses 427 are supported by a support portion (not illustrated). The support portion (not illustrated) movably supports each of the plurality of lenses 427 in the optical axis direction. The movement of each of the lenses in the optical axis direction is controlled by the recognition controller 715 of the controller 71 illustrated in FIG. 6, which will be described later.

The camera body 428 includes the imaging element (not illustrated) and an image processing circuit (not illustrated). The imaging element includes a plurality of light receiving elements formed of, for example, photodiodes and a drive circuit for driving each of the light receiving elements. Each light receiving element generates charges corresponding to the amount of light incident on the light receiving element. The drive circuit transmits, to the image processing circuit, a pixel signal corresponding to the charges generated in each of the light receiving elements. The image processing circuit converts the received pixel signal into image data. Then, the camera body 428 outputs the image data to the recognition controller 715 of the controller 71.

The camera body 428 may be constituted by a line sensor, an area sensor, or the like, or may be constituted by a camera with a depth sensor, a 3D camera capable of acquiring 3D point group information, or the like. In a case where the camera body 428 is formed with a camera with a depth sensor or a 3D camera, it is also possible to acquire information of unevenness of a component. The camera body 428 may include both a camera for 2D imaging and a 3D camera.

### <Configuration of Control System>

Next, a configuration of a control system of the component supply device 1 will be described with reference to FIG. 6. FIG. 6 is a block diagram illustrating an example of the configuration of the control system included in the component supply device 1.

As illustrated in FIG. 6, the component supply device 1 includes the controller 71, a memory 72, and the provider 4. The provider 4 has been described with reference to FIGS. 3 to 5, and thus the description thereof will be omitted. Each section that constitutes the controller 71 and the memory 72 is implemented by a hardware processor.

The controller 71 includes a whole controller 711, an arm controller 712, a hand controller 713, a distance measure controller 714, the recognition controller 715, a posture determinator 716, and a display controller 717.

The whole controller 711 is connected to the arm controller 712, the hand controller 713, the distance measure controller 714, the recognition controller 715, the posture determinator 716, and the display controller 717. The whole controller 711 receives, from the recognition controller 715, detection results such as the positions of the sections such as the containers 3A and 3B and the hand 422, the postures of components on the picking tables 5A and 5B, and the number of components held by the hand 422.

The whole controller 711 performs overall control of the arm controller 712 and the hand controller 713 based on the detection results received from the recognition controller 715, a supply parameter stored in the memory 72, and the like. The supply parameter is used to determine the operation of the provider 4 to supply a component to the picking table 5A or 5B or the placing table 6A or 6B. The supply parameter may include, for example, the position at which the hand 422 starts an operation of holding the component, the speed at which the component is conveyed by the arm 412, and the position at which the hand 422 releases the holding of the component.

The arm controller 712 is connected to a drive section of the arm 412. The arm controller 712 receives a control command from the whole controller 711. The arm controller 712 generates an arm drive signal for driving the arm 412, based on the control command received from the whole controller 711, and transmits the arm drive signal to the drive section of the arm 412. Thus, the arm 412 performs an operation corresponding to the control command of the whole controller 711.

The hand controller 713 is connected to a drive section of the hand 422. The hand controller 713 receives a control command from the whole controller 711. The hand controller 713 generates a hand drive signal for driving the hand 422, based on the control command received from the whole controller 711, and transmits the hand drive signal to the drive section of the hand 422. Thus, the hand 422 performs an operation corresponding to the control command of the whole controller 711.

The distance measure controller 714 is connected to each of the distance measuring sensors 423 provided in the two holding pieces 422a (see FIG. 5) of the hand 422. The distance measure controller 714 outputs, to the whole controller 711, information (distance measurement result information) of a distance to an end surface of the component measured by each of the distance measuring sensors 423 at a position determined by the recognition controller 715.

The recognition controller 715 is connected to the camera 424. The recognition controller 715 controls imaging by the camera 424 based on an imaging parameter 721 stored in the memory 72. Furthermore, the recognition controller 715 determines an imaging position of the camera 424 based on the image data transmitted from the camera 424 and calibration data (not illustrated).

Information of the imaging position of the camera 424 determined by the recognition controller 715 is transmitted to the whole controller 711. The whole controller 711 transmits, to the arm controller 712, a control command for controlling the operation of the arm 412 according to the imaging position determined by the recognition controller 715. The arm controller 712 controls the drive section of the arm 412 according to the control command of the whole controller 711. Thus, the camera 424 provided in the hand block 42 is positioned at the imaging position.

Further, the recognition controller 715 performs image processing on the image data received from the camera 424, based on an image processing parameter (various correction values) stored in the memory 72.

In addition, the recognition controller 715 detects, based on the image data transmitted from the camera 424, positions at which the two holding pieces 422a (see FIG. 5) of the hand 422 can be inserted into regions in the vicinity of side surface parts of a component, and transmits information of the detected positions to the whole controller 711. The two holding pieces 422a of the hand 422 are moved and inserted in regions in the vicinity of the side surface parts of the component by the hand controller 713 performing control based on the information transmitted to the whole controller 711 and indicating the positions where the two holding pieces 422a can be inserted.

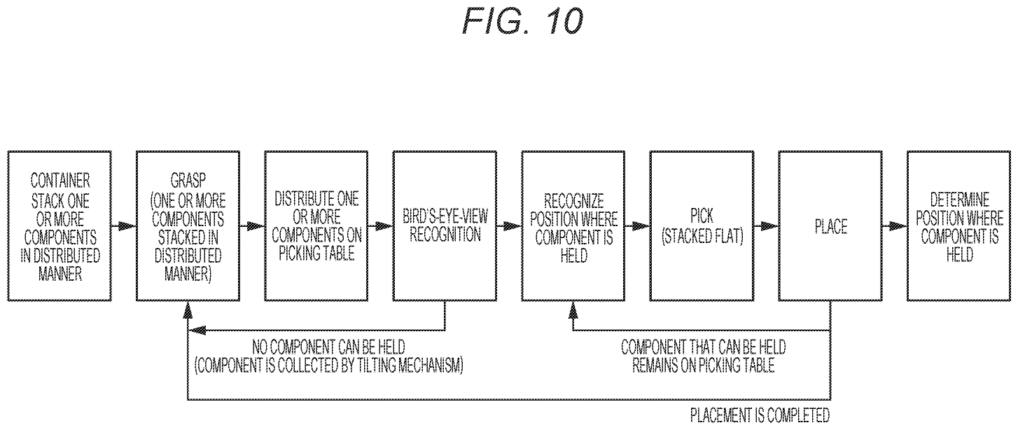

Further, after the two holding pieces 422a are inserted, the recognition controller 715 calculates a movement direction and movement amount of the hand 422 that are necessary for making the distances between the distance measuring sensors 423 and end parts of the component match a target distance dyt (see FIG. 10). Next, the recognition controller 715 outputs, to the whole controller 711, information of the calculated movement direction and movement amount of the hand 422. The hand controller 713 performs control based on the movement direction and the movement amount transmitted to the whole controller 711, whereby the two holding pieces 422a of the hand 422 are moved. As a result, the distances to the component measured by the distance measuring sensors 423 provided in the vicinity of the component holding parts of the two holding pieces 422a becomes the target distance dyt. The target distance dyt is a distance required to set a reference position to be referred to when the position of a region of interest on the component is determined.

The posture determinator 716 compares the image data subjected to the image processing with various templates 726 stored in the memory 72, and detects the types of components on the picking tables 5A and 5B. In addition, the posture determinator 716 determines (identifies) the position of the region of interest including the feature amount necessary for the determination of the posture of the component in the image data generated from the captured image, based on the image data of the image of the component captured by the camera 424 and the distance measurement result information by the distance measure controller 714.

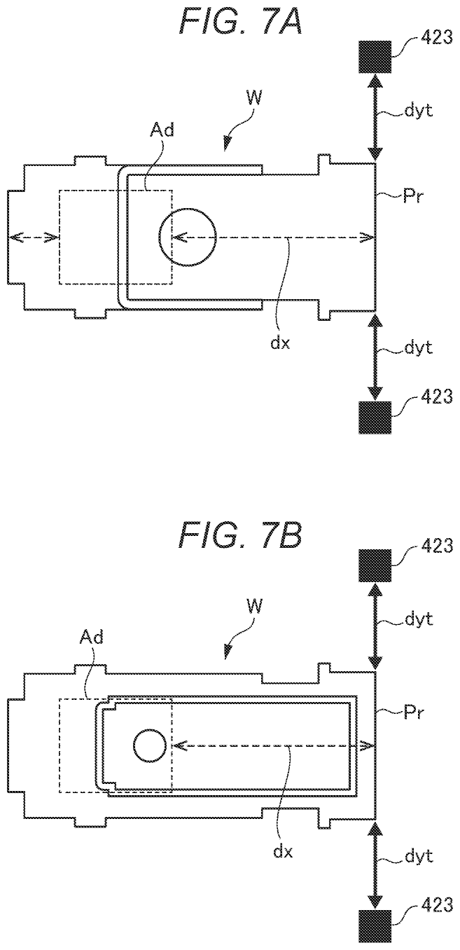

More specifically, the posture determinator 716 identifies the reference position in the image data based on the information of the arrangement positions of the two holding pieces 422a in a case where the distances to the component measured by the distance measuring sensors 423 become the target distance dyt. The posture determinator 716 sets the region of interest based on the identified reference position. The relationship between the target distance dyt, the reference position, and the region of interest will be described later with reference to FIGS. 7A, 7B, 8A, and 8B.

Furthermore, the posture determinator 716 determines the posture (front or back) of the component based on the result of comparison of the feature amount in the region of interest with information of a front/back determination reference amount stored in the memory 72. Then, the posture determinator 716 transmits the detection results and the determination result to the whole controller 711. The determination of the posture of the component by the posture determinator 716 can be performed by using an AI model for posture determination or the like. The AI model for posture determination can be generated by using information of the region of interest as training data.

The display controller 717 is connected to the operation display 8 (see FIG. 3). The display controller 717 receives a control command from the whole controller 711. The display controller 717 generates a display control signal for controlling the operation display 8 based on the control command received from the whole controller 711, and transmits the display control signal to the operation display 8. As a result, the operation display 8 displays various setting contents and the like according to the control command of the whole controller 711.

The memory 72 stores the imaging parameter 721, the image processing parameter 722, component shape information 723, hand opening width information 724, the front/back determination reference amount 725, and the various templates 726.

The imaging parameter 721 is used when the camera 424 captures an image of the component, the picking tables 5A and 5B, or the like. The imaging parameter 721 may include, for example, an exposure time, an amount of illumination light, and an image size according to the subject (imaging target).

The image processing parameter 722 includes various correction values used in performing the image processing on the image data received from the camera 424.

The component shape information 723 is information indicating the shape of the component, and includes, for example, information of the longitudinal size and the lateral size of the component. Note that when the camera 424 is a 3D camera, the component shape information 723 also includes information of unevenness of the component. Note that the component shape information 723 may be any information as long as it indicates the shape of the component, and may include, for example, contour information of the component.

The hand opening width information 724 is information indicating the interval (distance) between the two holding pieces 422a when the two holding pieces 422a of the hand 422 are in the open state.

The front/back determination reference amount 725 is a reference feature amount in the surface shape of the component. As the front/back determination reference amount 725, at least a first reference amount and a second reference amount are prepared for each type of component.

The first reference amount is a feature amount serving as a reference of the surface shape of a first surface (for example, the surface on the front side). The second reference amount is a feature amount serving as a reference of the surface shape of a second surface (for example, the surface on the back side). For example, each of the feature amounts is the number of edges (hereinafter, referred to as the “number of edges”). The posture determinator 716 determines the posture (front or back) of the component according to the result of determination as to whether the feature amount in the region of interest of the component detected from the image data is closer to or matches the first reference amount or the second reference amount.

The various templates 726 are templates for matching of two-dimensional shapes (outer shapes) of various components. At least one of the various templates 726 is prepared for each type of component.

The posture determinator 716 compares a two-dimensional shape of the component detected from the image data with the various templates 726, and detects the type of the component of the image data from a template that matches or is close to the image data.

### <Relationship Between Target Distance, Reference Position, and Region of Interest>

Next, the relationship between the target distance dyt, the reference position, and the region of interest will be described with reference to FIGS. 7A, 7B, 8A, and 8B. FIGS. 7A and 7B are diagrams illustrating a correspondence relationship between the target distance dyt, a reference position Pr, and the position of a region Ad of interest, and FIGS. 8A and 8B is a diagram illustrating a state in which distances to a component W measured by the distance measuring sensors 423 are the target distance dyt.

FIG. 7A is a diagram illustrating an example of setting of the region Ad of interest on the first surface (front surface) of the component W, and FIG. 7B is a diagram illustrating an example of setting of the region Ad of interest on the second face (back face) of the component W. As described above, the region of interest includes a feature amount necessary for the determination of the posture of the component.

For example, in a case where the outer shape of the first surface of the component W and the outer shape of the second surface of the component W are different from each other, the posture determinator 716 can determine the posture of the component W, that is, the front or back of the component W based on information of the outer shape of the component obtained from image data. However, as illustrated in FIGS. 7A and 7B, when the outer shape of the first surface and the outer shape of the second surface of the component W are the same or substantially the same, it is difficult for the posture determinator 716 to determine the posture of the component from the outer shape of the component W obtained from the image data.

Therefore, in the present embodiment, the posture determinator 716 determines whether the feature amount in the region Ad of interest of the surface shape of the component W is the feature amount on the first surface (hereinafter, also referred to as a “first reference amount”) or the feature amount on the second surface (hereinafter, also referred to as a “second reference amount”). As a result, the posture determinator 716 can determine the posture of the component W, that is, whether the first surface faces upward or the second surface faces upward.

In the present embodiment, as the feature amount to be used for determining the posture of the component W, a feature amount in a region where the difference in the number of edges between the first surface and the second surface is assumed to be large is used. Then, the region including the feature amount is set as the region Ad of interest. The region Ad of interest can be formed in, for example, a rectangular shape.

As illustrated in FIGS. 7A and 7B, the reference position Pr is set on one of two end surfaces of the component W that are opposed to each other in the lateral direction of the component W. Then, the region Ad of interest is set at a position advanced from the reference position Pr by a distance dx in the horizontal direction. It is assumed that the position of the reference position Pr in the outer shape of the component W, the shape and size of the region Ad of interest, and the distance dx from the reference position Pr to one side of the region Ad of interest are registered in advance as parameters in the component shape information 723 (see FIG. 6).

Then, the posture determinator 716 sets the reference position Pr when the distances to the end surfaces of the side surface parts of the component W measured by the distance measuring sensors 423 becomes the target distance dyt. In this case, the posture determinator 716 sets the reference position Pr at the positions (positions in the image data) of the end surfaces of the component W that are in the vicinity of the arrangement positions of the distance measuring sensors 423. Next, the posture determinator 716 sets the region Ad of interest at a position advanced from the reference position Pr by the distance dx in the horizontal direction (direction along the upper surface of the component W) in the image data. By performing the above-described process, the posture determinator 716 can identify the position of the region Ad of interest including the feature amount to be used for the determination of the posture of the component W in the image data obtained by capturing the image of the component W.

Note that a place where an edge appears varies depending on the type of the component W, a mold for molding the component W, the posture of the component W, and the like. Therefore, it is preferable that the region Ad of interest is set at least for each of types of components W. In addition, in a case where different molds are used according to production lots of the components W, a determination region may be set for each of the production lots of the components W or for each of the molds.

Further, the region Ad of interest is not limited to one region, and may be two or more regions. In a case where two or more regions Ad of interest are present, the posture determinator 716 can determine the posture of the component W by, for example, comparing the sum of detected edges with a reference number of edges. Furthermore, in a case where two or more regions Ad of interest are present, the posture determinator 716 may determine the posture of the component W by comparing the ratio of the number of edges detected in each region Ad of interest with the ratio of the reference number of edges in each determination region.

Furthermore, the feature amount is not limited to the number of edges, but may be, for example, the length of an edge, the area of an edge, or a texture.

FIG. 8A is a front view of the component W and the hand 422, and FIG. 8B is a side view of the component W and the hand 422. FIGS. 8A and 8B illustrate the hand 422 in a simplified manner.

The target distance dyt is a distance that is assumed to be measured by each of the distance measuring sensors 423 provided at substantially the distal end parts of the two holding pieces 422a in a case where the two holding pieces 422a are arranged in the vicinity of the reference position Pr and the component W is positioned at a substantially central portion between the two holding pieces 422a in the open state. The target distance dyt is set in advance based on an opening width Wdh defined in the hand opening width information 724 and a lateral width (width in the lateral direction) Wdw of the component W in the vicinity of the reference position Pr.

Next, the posture determinator 716 (see FIG. 6) sets the reference position Pr at a position that is assumed to be the reference position Pr in the image data captured by the camera 424. To be specific, when the distances between the distance measuring sensors 423 and the end surfaces of the component W reach the target distance dyt, the posture determinator 716 sets, as the reference position Pr, the end surfaces (or end sides in a case where the image data is two-dimensional data) of the component W located at a position where the two holding pieces 422a can hold the component W.

In the present embodiment, by performing such processing, the position of the reference position Pr in the image data can be identified and the position of the region Ad of interest can also be identified based on the reference position Pr, without performing processing such as accurately cutting out information of the outer shape of the component W from the image data. Therefore, according to the present embodiment, for example, even in a situation in which it is difficult to accurately cut out information of the outer shape of the component W from the image data due to contact, overlap, or the like between the component W and another component W, it is possible to determine the posture of the component W based on the feature amount in the region Ad of interest identified based on the results of the distance measurement by the distance measuring sensors 723.

In the present embodiment, an example in which the reference position Pr is set to a specific end surface (or end side) among a plurality of end surfaces constituting the component W will be described, but the present invention is not limited thereto. The reference position Pr may be set at, for example, a place having a specific feature on the component W, such as a rib formation part.

### <Hardware Configuration>

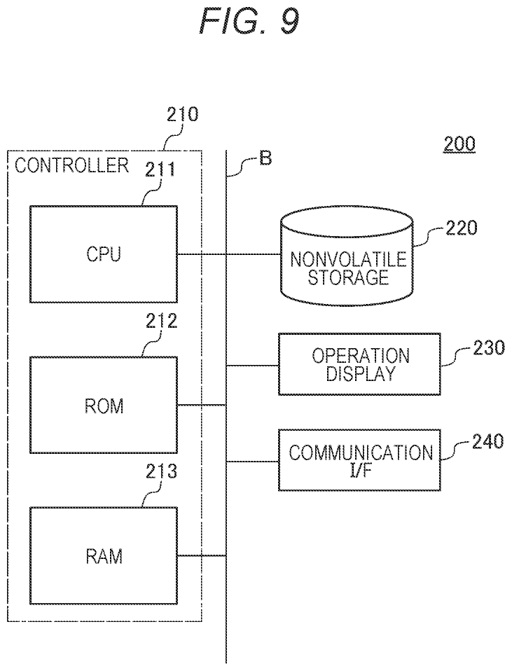

Next, a hardware configuration of the component supply device 1 will be described with reference to FIG. 9. FIG. 9 is a block diagram illustrating an example of the hardware configuration of the component supply device 1. A computing machine 200 illustrated in FIG. 9 is hardware which is used as a so-called computer.

The computing machine 200 includes a controller 210, a nonvolatile storage 220, an operation display 230, and a communication I/F (interface) 240, which are connected to a bus B.

The controller 210 includes a central processing unit (CPU) 211, a read only memory (ROM) 212, and a random access memory (RAM) 213.

The CPU 211 reads, from the ROM 212, a program code of software that implements each function according to the present embodiment, develops the program code in the RAM 213, and executes the program code. Note that the computing machine 200 may include a processing unit such as a micro-processing unit (MPU) instead of the CPU 211. Variables, parameters, and the like generated in the middle of arithmetic processing are temporarily written in the RAM 213.

As the nonvolatile storage 220, for example, a hard disk drive (HDD), a solid state drive (SSD), a flexible disk, an optical disc, a magneto-optical disc, a CD-ROM, a CD-R, a nonvolatile memory card, or the like can be used. In the nonvolatile storage 220, a program or the like that causes the computing machine 200 to function is recorded in addition to an operating system (OS) and various parameters. The program may be stored in the ROM 212.

The program is stored in the form of a computer-readable program code, and the CPU 211 sequentially executes operations according to the program code. That is, the ROM 212 or the nonvolatile storage 220 is used as an example of a computer-readable non-transitory recording medium that stores the program to be executed by the computer.

The various functions of the controller 71 (see FIG. 6) of the component supply device 1 are implemented by the CPU 211 executing a predetermined processing program stored in the ROM 212. The various functions of the controller 71 include, for example, the control of the operation of the arm 412 by the arm controller 712, the control of the operation of the hand 422 by the hand controller 713, the control of the operation of the distance measuring sensors 423 by the distance measure controller 714, a process of determining a posture of a component by the posture determinator 716, and the control of display of the operation display 8 by the display controller 717.

In addition, the function of the memory 72 (see FIG. 6) of the component supply device 1 is implemented by the nonvolatile storage 220 or the ROM 212.

The operation display 230 is configured as, for example, a touch screen in which a display panel constituted by a liquid crystal display (LCD) or the like and an operation input unit constituted by a touch sensor are integrally formed. Note that the display panel and the operation input unit may be configured as separate devices.

For example, a network interface card (NIC) or the like is used for the communication I/F 240, and various kinds of data can be transmitted to and received from an external device (not illustrated) via a network or a communication line.

### [Component Supply Operation of Component Supply Device]

Next, a description will be given of a component supply operation of the component supply device 1 with reference to FIG. 10.

FIG. 10 is a diagram illustrating the component supply operation of the component supply device 1.

As illustrated in FIG. 10, in order to supply components to the device for the next process by the component supply device 1, first, the components are stored in the container 3A or 3B (hereinafter, referred to as a “container 3”) (see FIG. 1). The storage of the components in the container 3 may be performed by a device for a previous process or may be manually performed by a person.

Next, the provider 4 holds one or a plurality of components from a large amount of components stored in the container 3, and supplies the one or the plurality of components to the picking table 5A or the picking table 5B (hereinafter, referred to as a “picking table 5”). In this case, the provider 4 performs a supply operation such that the one or plurality of held components are distributed on the picking table 5. The supply operation in which the components are distributed on the picking table 5 is referred to as a “component distribution operation”.

Next, the camera 424 captures an image of the front surface of the picking table 5, and the recognition controller 715 of the controller 71 recognizes the front surface of the picking table 5 in a bird's eye view. In this case, the recognition controller 715 determines whether or not a component that can be held is present on the picking table 5. When the recognition controller 715 determines that a component that can be held is not present on the picking table 5, the provider 4 holds one or a plurality of components from a large amount of components stored in the container 3.

Even in a case where a component is present on the picking table 5, when the component is located at a position where the component cannot be held by the provider 4, the recognition controller 715 determines that a component that can be held is not present on the picking table 5. In this case, a tilting mechanism is driven to tilt the picking table 5. Thus, the component placed on the picking table 5 drops from the picking table 5 and is collected into the container 3.

When recognition controller 715 determines that a component that can be held is present on the picking table 5, the recognition controller 715 determines one of components on the picking table 5 as a component to be held, and causes the camera 424 to capture an image of the component to be held. Then, the posture determinator 716 determines the posture (front or back) of the component from image data of the component to be held. Thereafter, the hand controller 713 recognizes (determines) the position at which the hand 422 of the provider 4 holds the component.

Next, the provider 4 holds the one component and supplies the component to the placing table 6A or 6B (hereinafter, referred to as a “placing table 6”). The placing table 6 positions the supplied component at a predetermined position. The component positioned at the predetermined position is supplied to the device for the next process.

When the provider 4 supplies one component to the placing table 6, the posture determinator 716 determines one of components present on the picking table 5 as a component to be held. Then, as described above, the posture determinator 716 determines the posture (front or back) of the component and recognizes (determines) the position at which the hand 422 of the provider 4 holds the component. In this case, in a case where a component is not present on the picking table 5, the operation of supplying the component to the placing table 6 is completed. Next, the provider 4 holds one or more components from a large amount of components stored in the container 3. Thereafter, the provider 4 repeats the supply of one or more components to the placing table 6 by performing the component distribution operation.

According to the present embodiment, even in a case where components are in contact with each other, overlap each other, or the like, the posture determinator 716 can determine the postures of the components, and thus it is possible to omit the processing of “distributing” the components on the picking table 5.

### <Posture Determination Process>

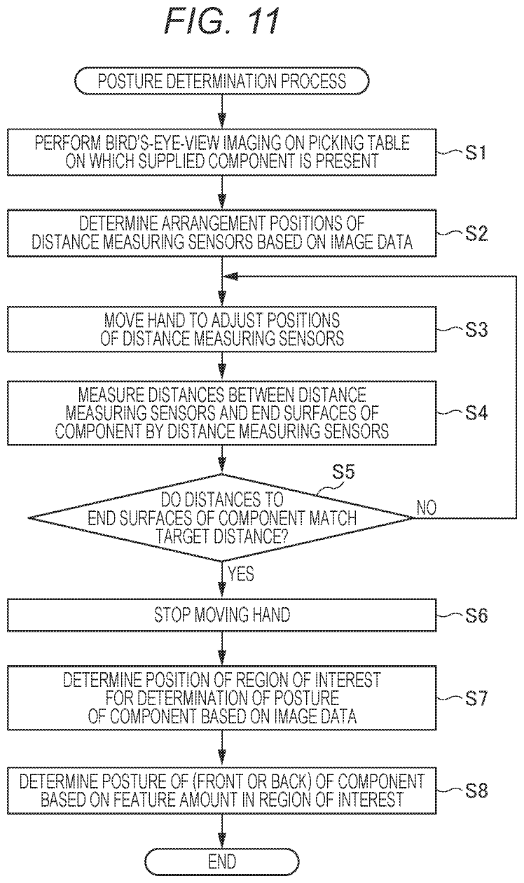

Next, a posture determination process to be performed by the component supply device 1 will be described with reference to FIGS. 11 to 13C.

FIG. 11 is a flowchart illustrating an example of a procedure of the posture determination process according to the present embodiment.

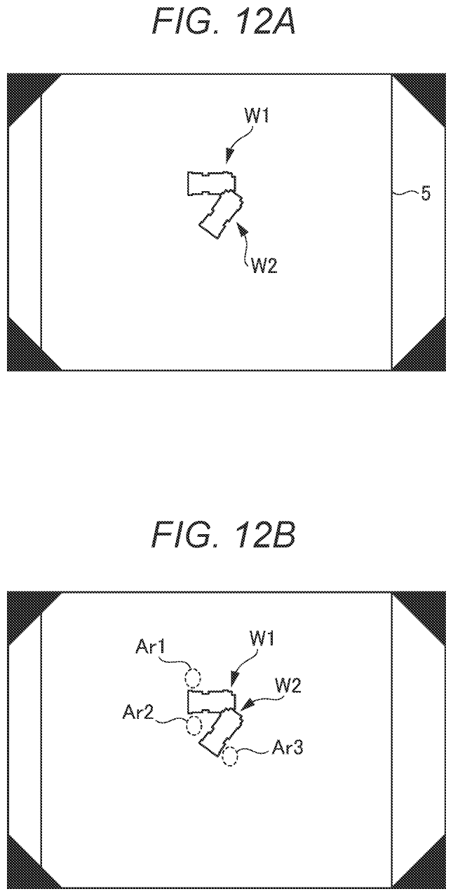

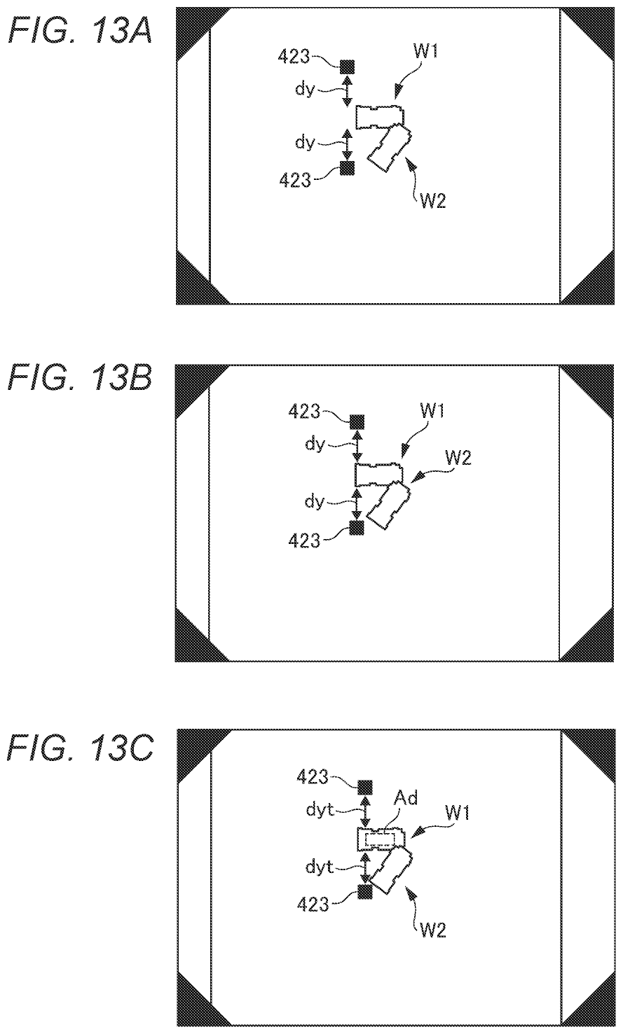

FIGS. 12A, 12B, 13A, 13B, and 13C are diagrams illustrating each process of the posture determination process.

First, the recognition controller 715 causes the camera 424 to perform bird's-eye-view imaging to capture an image of the picking table 5 (see FIG. 1) on which a supplied component is present (step S1). FIG. 12A is a diagram illustrating an image of bird's-eye-view imaging by the camera 424. FIG. 12A illustrates an example in which the component W1 and a component W2 are placed on the picking table 5 in a state in which parts of the components W1 and W2 overlap each other. Next, the recognition controller 715 determines the arrangement positions of the distance measuring sensors 423 based on image data of the image captured in step S1 (step S2).

FIG. 12B illustrates an example of the arrangement positions of the distance measuring sensors 423 recognized by the recognition controller 715. FIG. 12B illustrates a state in which arrangement positions Ar1 and Ar2 where it is possible to measure distances to end surfaces of the component W1 on the left end side of both side surfaces of the component W1 in the longitudinal direction of the component W1 in the drawing and arrangement positions Ar2 and Ar3 where it is possible to measure distances to end surfaces of the component W2 on the lower side of both side surfaces of the component W2 in the longitudinal direction of the component W2 in the drawing are recognized as the arrangement positions of the distance measuring sensors 423.

Prior to the determination of the arrangement positions of the distance measuring sensors 423, the recognition controller 715 cuts out regions (outlines) of the individual components W1 and W2 from the image data generated by the camera 424. The cutout of the regions of the individual components W can be executed, for example, by using information of the areas of images or by using an instance segmentation technique using deep learning. Then, the recognition controller 715 determines regions which are in the vicinity of the end surfaces of the side surface parts of the components and into which the two holding pieces 422a to which the distance measuring sensors 423 are attached can be inserted, as the arrangement positions of the distance measuring sensors 423.

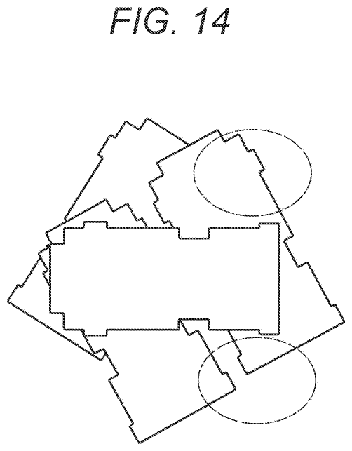

FIG. 14 is a diagram illustrating an example of determining the arrangement positions of the distance measuring sensors 423 in a state where a plurality of components are stacked. In a case where the camera 424 is capable of also acquiring depth information, the recognition controller 715 can determine the arrangement positions (regions indicated by ellipses of dash-dot lines in the drawing) of the distance measuring sensors 423 by also referring to the depth information acquired by the camera 424.

Referring back to FIG. 11, the description is continued. After the processing in step S2, the hand controller 713 moves the hand 422 to the arrangement positions determined in step S2, thereby adjusting the positions of the distance measuring sensors 423 provided at the distal end parts of the two holding pieces 422a (step S3). FIG. 13A is a diagram illustrating a state in which the distance measuring sensors 423 do not capture the end surfaces of the component W1. FIG. 13B is a diagram illustrating a state in which the distance measuring sensors 423 are arranged at positions where the distance measuring sensors 423 can measure distances to the end surfaces of the component W1.

As illustrated in FIG. 13B, when the distance measuring sensors 423 are arranged at positions where the distance measuring sensors 423 can measure the distances to the end surfaces of the component W1, the distance measuring sensors 423 measure distances dy to the end surfaces of the component W1 (step S4 in FIG. 11). Next, the recognition controller 715 determines whether or not the distances dy to the end surfaces of the component W1 measured by the distance measuring sensors 423 match the target distance dyt (step S5).

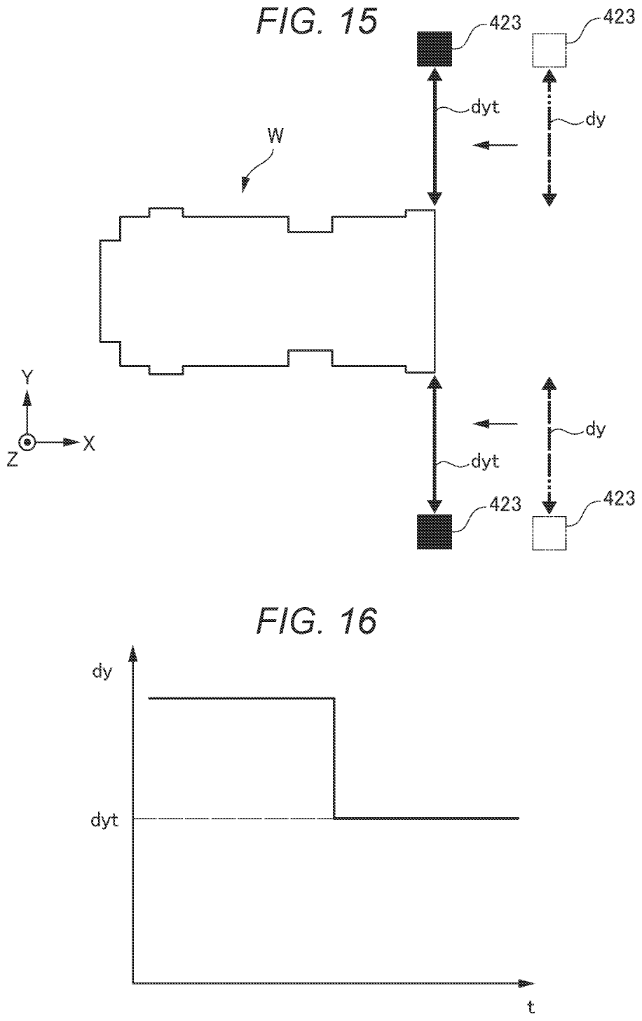

Here, an example of the measurement of the distances dy to the end surfaces of the component W by the distance measuring sensors 423 will be described with reference to FIGS. 15 and 16. FIG. 15 is a diagram illustrating an example of a positional relationship between the distance measuring sensors 423 and the component W, and FIG. 16 is a graph illustrating an example of values measured by the distance measuring sensors 423.

The vertical axis in FIG. 16 represents the distances dy to the component W measured by the distance measuring sensors 423, and the horizontal axis in FIG. 16 represents time (t).

As illustrated in FIG. 15, it is assumed that the distance measuring sensors 423 gradually move toward the component W from the right side in the drawing. In this case, until the distance measuring sensors 423 detect the component W, the values measured by the distance measuring sensors 423 are a default value in a case where nothing is detected. The default value is a value corresponding to a distance between a light emitting unit (not illustrated) and a light receiving unit (not illustrated) of each of the distance measuring sensors 423.

On the other hand, when the end surfaces (the surfaces on which the reference position Pr is set) of the component W are arranged at substantially central portions between the light emitting units and the light receiving units of the distance measuring sensors 423, as illustrated in the graph of FIG. 16, the values measured by the distance measuring sensors 423 become the target value dyt.

In step S2 in FIG. 11, the component for which the arrangement positions of the distance measuring sensors 423 are determined may be obliquely inclined due to a reason such as being stacked on another component. In this case, the hand controller 713 (see FIG. 6) adjusts the inclination of the hand 422 based on information obtained from image data output from the camera 424.

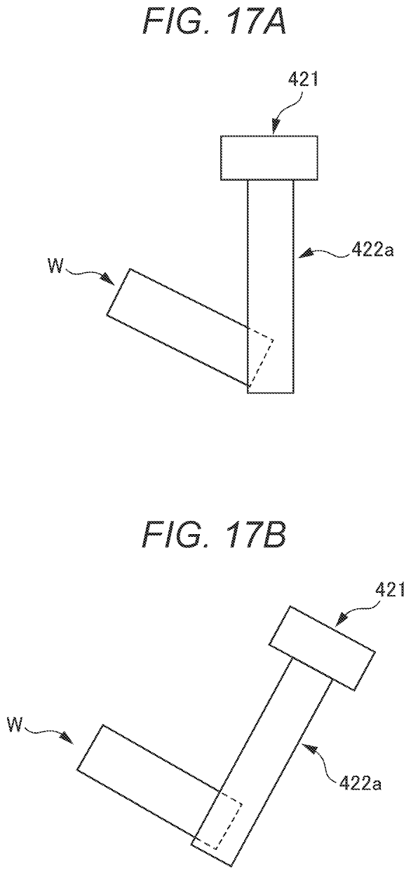

FIGS. 17A and 17B are diagrams illustrating an example of the adjustment of the inclination of the hand 422. In the example illustrated in FIG. 17A, the component W inclines downward to the right. In this case, the hand controller 713 adjusts angles formed by an axis of the component W in the longitudinal direction of the component W and axes of the two holding pieces 422a to be approximately 90° by tilting the hand 422 in a diagonally lower right direction in the drawing. When the hand controller 713 performs such adjustment, the distance measuring sensors 423 (not illustrated in FIGS. 17A and 17B) attached to the substantially distal end parts of the two holding pieces 422a can appropriately measure the distances to the end parts of the side surfaces of the component W.

Referring back to FIG. 11, the description is continued. When the recognition controller 715 determines in step S5 that the distances to the end surfaces of the component do not match the target distance dyt (NO in step S5), the process returns to step S3 and the processing is performed in step S3.

On the other hand, when the recognition controller 715 determines in step S5 that the distances between the distance measuring sensors 423 and the end surfaces of the component match the target length dyt (YES in step S5), the hand controller 713 stops the movement of the hand 422 (step S6).

Next, the posture determinator 716 determines the position of the region of interest for posture determination (step S7). This determination of the region of interest is performed based on the image data generated by the camera 424, information of the positions (coordinate positions) of (the two holding pieces 422a of) the hand 422 stopped in step S6, and information of the results of measuring the distances by the distance measuring sensors 423. FIG. 13B illustrates a state in which the position of the region Ad of interest is determined based on the reference position Pr defined by the information of the positions of the two holding pieces 422a of the hand 422.

Next, the posture determinator 716 determines the posture (front or back) of the component based on the information of the feature amount in the region of interest determined in step S7 and the front/back determination reference amount 725 stored in the memory 72 (step S8). After the processing in step S8, the posture determination process by the component supply device 1 ends.

In the embodiment described above, the posture determinator 716 of the component supply device 1 determines the position of the region Ad of interest to be used for determining the posture of the component W in the captured image obtained by capturing the image of the component W from above. The determination of the position of the region Ad of interest is performed based on information of the arrangement positions of the distance measuring sensors 423 in a case where distances from the distance measuring sensors 423 to the side surfaces of the component W measured by the distance measuring sensors 423 are the predetermined target distance dyt. Then, the posture determinator 716 determines the posture of the component W based on the feature amount in the region Ad of interest.

Therefore, according to the present embodiment, even when the outer shape of the component W cannot be strictly extracted because a part of the component W is in contact with or overlaps another component, the posture determinator 716 can determine the posture of the component W based on the information of the distances to the component W measured by the distance measuring sensors 423.

In addition, in the posture determination process according to the present embodiment, even when edge shapes differ for each component, it is possible to compare the detected feature amount with the predetermined reference amount in the region of interest which is less affected by the differences. As a result, the posture (front or back) of the component can be accurately determined.

Note that for example, for a component or the like whose left/right direction is difficult to identify from image data, the posture determinator 716 may set the region Ad of interest to be relatively large.

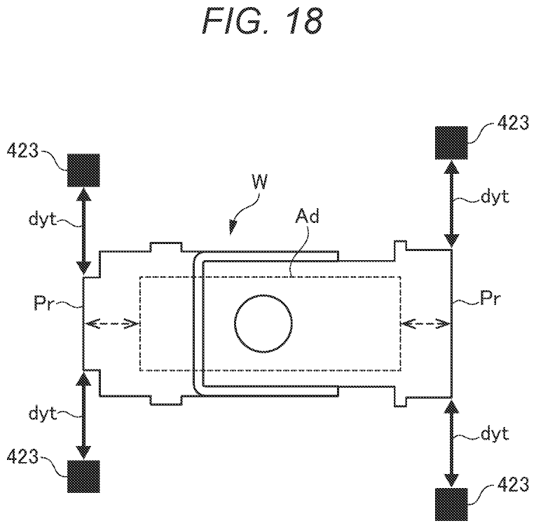

FIG. 18 is a diagram illustrating an example in which the region Ad of interest is set in a wide range of the component W. As illustrated in FIG. 18, by setting the region Ad of interest capable of covering a wide region in the longitudinal direction of the component W, it is possible to set the reference position Pr on each of the two end surfaces of the component W in the lateral direction.

Accordingly, even in a case where it is difficult to identify, from image data, left and right directions of the component W that is a target of the posture determination, the posture determinator 716 can identify the region Ad of interest including the feature amount necessary for the posture determination in a case where any one of reference positions Pr set on the two end surfaces can be recognized, and thus can determine the posture of the component W.

Further, as illustrated in FIG. 18, two reference positions Pr are provided. Thus, even if positions where the two holding pieces 422a can be inserted cannot be detected in the vicinity of any of the end surfaces on which the reference positions Pr are set, the posture determinator 716 can determine the posture of the component W as long as the holding pieces 422a can be inserted into regions in the vicinity of the other reference position Pr. That is, according to the modification example, it is possible to improve the probability that the recognition controller 715 can detect regions in which the distance measuring sensors 423 provided in the vicinity of the component holding parts of the two holding pieces 422a can be arranged.

The number of reference positions Pr is not limited to two, and three or more reference positions Pr may be set according to the shape of the component W. Further, also in a case where the size of the region Ad of interest is the size illustrated in FIGS. 7A and 7B, that is, the smallest size that includes the feature amount necessary for the determination of the posture of the component, a plurality of reference positions Pr may be set.

Furthermore, the present invention is not limited to the above-described embodiment, and it is needless to say that other various application examples and modification examples can be adopted without departing from the spirit and scope of the present invention described in the claims.

For example, in the above-described embodiment, the configuration of the device has been described in detail and specifically in order to describe the present invention in an easy-to-understand manner, and the present invention is not necessarily limited to one including all the described configurations.

Although embodiments of the present invention have been described and illustrated in detail, the disclosed embodiments are made for purposes of illustration and example only and not limitation. The scope of the present invention should be interpreted by terms of the appended claims.

What is claimed is:

1. A component posture information acquiring device that acquires information of a posture of a component from a hand that holds the component arranged on a picking table and places the component at a supply position, the component posture information acquiring device comprising:
a distance measure that is provided in a vicinity of a component holding part of the hand and measures a distance from the distance measure to the component; and
a hardware processor that determines the posture of the component, wherein
the hardware processor determines a region of interest to be used for determining the posture of the component based on information of an arrangement position of the distance measure when the measured distance becomes a predetermined distance, and
the hardware processor determines the posture of the component based on a feature amount in the region of interest.

2. The component posture information acquiring device according to claim 1, wherein the region of interest is a region in which a difference between a feature amount on a first surface of the component and a feature amount on a second surface different from the first surface is assumed to be large.

3. The component posture information acquiring device according to claim 2, wherein the predetermined distance is a distance from the distance measure to a side surface of the component in a case where the distance measure is arranged in a vicinity of the side surface at a reference position which is referred to for the determination of the region of interest.

4. The component posture information acquiring device according to claim 3, wherein the reference position is set on a specific end surface forming an outer shape of the component recognized from a captured image of the component from above, or is set at a place having a specific feature.

5. The component posture information acquiring device according to claim 4, wherein the hardware processor sets the region of interest at a position moved from the reference position in a predetermined direction by a predetermined movement amount in parallel along a surface of the component on an upward side of the component.

6. The component posture information acquiring device according to claim 5, wherein the predetermined distance is set in advance based on information of an opening width of the hand and information of a width of the component.

7. The component posture information acquiring device according to claim 6, further comprising:
a camera that is arranged above the picking table on which the component is placed, and outputs at least one of a two-dimensional captured image of the component, three dimensional point group information of the component, and depth information of the component, wherein
the hardware processor determines a position at which the hand provided with the distance measure can be arranged, based on the information output from the camera, and
the hardware processor adjusts the position of the distance measure until the distance from the distance measure to the side surface of the component becomes the predetermined distance when the hand is arranged at the arrangement position.

8. A component posture determination method for determining information of a posture of a component from a hand that holds the component arranged on a picking table and places the component at a supply position, the component posture determination method comprising:
measuring a distance from a distance measure to the component by the distance measure provided in a vicinity of a component holding part of the hand;
determining a region of interest to be used for determining the posture of the component based on information of an arrangement position of the distance measure when the measured distance becomes a predetermined distance; and
determining the posture of the component based on a feature amount in the region of interest.
